(19) United States
(12) Patent Application Publication
(10) Pub. No.: US 2021/0070957 A1
(43) Pub. Date: Mar. 11, 2021

(54) BIODEGRADABLE FLORAL FOAMS

(71) Applicants: Debora Flanagan Massouda, Wilmington, DE (US); Nikolay Vladimirov, Newark, DE (US); Andrew Ehmann, Middletown, DE (US); Charles Koerting, Kemblesville, PA (US)

(72) Inventors: Debora Flanagan Massouda, Wilmington, DE (US); Nikolay Vladimirov, Newark, DE (US); Andrew Ehmann, Middletown, DE (US); Charles Koerting, Kemblesville, PA (US)

(21) Appl. No.: 17/015,606

(22) Filed: Sep. 9, 2020

Related U.S. Application Data
(60) Provisional application No. 62/897,689, filed on Sep. 9, 2019.

(51) Int. Cl. C08J 9/26

(52) U.S. Cl. CPC C08J 9/26; C08J 2367/00; C08J 2301/02

(57) ABSTRACT

An open-cell biodegradable foam material selected from cellulose and polylactic acid having a structure capable of supporting stems of cut flowers and process for its production.

### BACKGROUND OF THE INVENTION

The described and claimed inventive concept(s) relate to floral foams, and, more particularly, to floral foams derived from materials, such as, for example, cellulose and polylactide, which are absorbent, moisture-retaining and have sufficient strength to support stems of cut flowers while also being biodegradable, and to processes/methods for their preparation.

Floral foam is used to anchor freshly cut flowers in an arrangement while delivering water and sometimes nutrients to extend the flower life. The most common type of floral foam, which is used commercially, is a phenol-formaldehyde foam of the type disclosed in U.S. Pat. No. 2,753,277. Phenol-formaldehyde foam, however, is derived from petroleum based materials and does not degrade in normal landfills.

There is a need today for a floral foam which imparts a lower environmental impact. The environment is no longer suitable for disposal of plastics, especially ones that are non-biodegradable or compostable, or are only slowly degradable under well-controlled conditions. There is also a desire today to use materials that are bio-derived, and not based on petroleum.

### SUMMARY OF THE INVENTION

The described and claimed inventive concept(s) relate to an open-cell biodegradable polymeric foam having a structure that is capable of supporting stems of cut flowers. Such open-cell polymeric foam material is frangible when saturated with water whereby the stems of flowers will penetrate the foam without distortion thereof. The foam structure also has a multiplicity of small bubble-like voids adapted to carry water into the interior thereof whereby the useful life of the cut flowers can be extended. A preferred biodegradable polymeric foam material is selected from cellulose and polylactic acid. A polymeric foam material comprising cellulose or polylactic acid is degraded by methods described herein with the result that it becomes brittle enough to insert and support cut flower stems.

According to one embodiment, the foamed polymeric material is a cellulose sponge which is treated with a cellulase enzyme to thereby degrade the cellulose according to an enzymatic reaction, which can be accomplished over a wide range of pH, enzyme concentrations and temperatures. The enzymatic reaction can be terminated by raising the temperature to a value high enough that the enzyme is de-activated. Alternatively, the enzyme can also be de-activated by drying or it can be removed by rinsing.

According to another embodiment, enzymatic degradation of cellulose sponge can be accomplished using a cellulase enzyme (EC 232-734-4) from Aspergillus Niger, which is known to catalyze the hydrolysis of endo-1,4-βD-glycosidic linkages in cellulose.

According to yet another embodiment, enzymatic degradation of polylactic acid (PLA) foam can be accomplished by exposing it to an alcalase enzyme, which, in turn, renders the PLA foam brittle enough for insertion of fleshly cut flower stems.

### DETAILED DESCRIPTION OF THE INVENTION

Before explaining at least one embodiment of the presently disclosed and claimed inventive concept(s) in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed and claimed herein can be made and executed without undue experimentation in light of the present disclosure. While the articles and methods of the presently disclosed and claimed inventive concept(s) have been described in terms of particular embodiments, it will be apparent to those of skill in the art that variations may be applied to the articles and/or methods and in the steps or in the sequence of steps of the method described herein without departing from the concept, spirit and scope of the presently disclosed and claimed inventive concept(s). All such similar substitutes and modifications apparent to those skilled in the art are deemed to be within the spirit, scope and concept of the presently disclosed and claimed inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

While how to make a foam from a biodegradable/bioderived polymer, i.e., a polymeric material, is known to those skilled in the art, the challenge has been to find a biodegradable material that is tough enough to enable foam formation while at the same time being fragile enough to enable the insertion of freshly cut flower stems and rigid enough to hold them in place. Low molecular weight polymers tend to be fragile and brittle, but they cannot be easily formed into a foam without blowing apart the structure in the process. (See discussion in “Foaming of Synthetic and Natural Biodegradable Polymers”, Marrazzo, et al., Journal of Cellular Plastics (43) March 2007, p123.) Phenol-formaldehyde foams currently used as floral foams get around the issue of needing to be tough and also brittle by forming the foam during polymerization, which is then finished by forming crosslinks to render the foam more brittle.

Floral foams must be hydrophilic without being too sensitive to water. For example, starch foams exist, but they are too water-sensitive and tend to collapse into an un-formed mass when wetted.

Foams are cellular materials, that is, materials with internal voids. Open-cell foams have voids that are interconnected, while the voids in closed-cell foams are separated by walls. The inventive concept(s) described herein focuses on open-cell foams formed from polymers that are bio-degradable. A sponge is such an open-cell foam that is highly absorbent, taking up many times its weight in liquid. The liquid of interest for the floral and horticultural industry is water. Open-cell foams can either be inherently hydrophilic to absorb water, or, if not hydrophilic, they can be treated with surfactants to become a sponge to adsorb water.

Foams can be created by any of a number of techniques known to those skilled in the art, including through formation of a gas released by a chemical reaction, introduction of a blowing agent and melting of an additive that leaves pores behind. New approaches to making environmentally friendly foams are constantly being developed. See for example: “Cellulose Nanostructure-Based Biodegradable Nanocomposite Foams: A Brief Overview on the Recent Advancements and Perspectives”, Motloung et al., Polymers 2019, 11, 1270; doi:10.3390/polym11081270. All of the described biodegradable foams would be suitable starting materials for practicing the described inventive concept(s).

Blends of biodegradable polymers, including blends with chitosan, starch or alpha 1,3 glucan polymers (e.g. those used in U.S. Pat. No. 9,644,322) would make suitable starting materials in foam form. Foams can also contain fibers or inorganic fillers as needed to modify their mechanical properties or improve cost. The challenge has been to produce a floral foam from a biodegradable material that is also brittle enough for insertion of cut flower stems yet also rigid while wet to hold the flower stems in place.

According to one embodiment, a preferred starting foam is a cellulose sponge. An advantage of using a cellulose sponge as the basis for a floral foam is that it will degrade at the same rate or faster than the flowers themselves. It can be disposed of with the flowers, and from that point on, it will have a similar impact on the environment as the discarded flowers.

Depending on the degree of degradation selected, degraded foam as taught herein could also be reused several times as a floral foam. Alternatively, these floral foams could be recycled and used in a second life as soil enhancers to help retain moisture. Since these floral foams are naturally brittle, then can be easily cut or ground into pellets or powder for blending with soil.

### EXAMPLES

A preferred approach according to the inventive concept(s) described and claimed herein is to begin with a cellulose sponge and use a cellulase enzyme to partially degrade the cellulose, i.e., degrade the cellulose to an extent that the sponge structure becomes fragile enough to enable the insertion of freshly cut flower stems yet remains rigid enough to hold them in place. Enzymatic degradation has been observed to create a satisfactory water-retentive mass over a wide range of pH, enzyme concentrations and temperatures. The enzymatic degradation reaction can be terminated by raising the temperature to a value high enough to de-activate the enzyme. Degradation can also be terminated by rinsing the enzyme from the sponge/foam or by drying the sponge/foam.

According to an alternate embodiment, an open-cell polylactic acid (PLA) foam can be exposed to an alcalase enzyme to make it brittle enough for insertion of fleshly cut flower stems. Any other enzyme known to degrade PLA can be used according to the inventive concept(s) described and claimed herein.

### Examples 1 to 7

Examples 1 to 7 illustrate formation of a floral foam by enzymatic degradation of a cellulose sponge using a cellulase enzyme (EC 232-734-4) from Aspergillus Niger, which is known to catalyze the hydrolysis of endo-1,4-βD-glycosidic linkages in cellulose. Cellulase enzymes from other sources, such as Trichoderma Virde and Trichoderma Reesei are also expected to produce satisfactory results when conditions are properly chosen.

General procedure for Examples 1 to 7:
A 100% cellulose sponge was selected and cut to desired cylindrical shape (2″ in diameter and 2″ thick) and set aside.
600 ml of water was placed in an 800 ml beaker.
Monobasic ammonium dihydrogen phosphate (NH₄H₂PO₄) was added to the water to prepare 0.1 Mol solution.
pH of the solution was adjusted to 4.5 to facilitate enzymatic degradation by adding dropwise a solution of 0.1 Mol dibasic ammonium hydrogen phosphate ((NH₄)₂HPO₄), allowing about 2 to 3 minutes in between additions for the solution to equilibrate and for the pH meter to achieve a stable reading.
The target amount of cellulase was added to the solution and stirred.
Because of its buoyancy, the sponge was weighed down (by placing a stir bar on top) to keep it submerged.
The beaker with the solution and immersed sponge was covered to minimize evaporation and placed in an oven held at 40° C. for the necessary reaction time.
Twice per day, the sponge was depressed and released with a spatula to cause the solution in the pores of the sponge to be expelled and refilled.
Degradation status was checked periodically by poking the sponge with an angled cut plastic pipette tip to mimic a cut flower stem. When the pipette tip could penetrate the wet sponge to the desired degree, the reaction was ended.
The reaction was stopped by placing the sponge in boiling water for 3 minutes.
The sponge was then air dried.

The range of conditions studied are shown in Table 1. The results indicate that when not enough reaction occurs, the foam is not satisfactory and that when degradation is carried too far, the foam is not satisfactory. This is not intended to limit the invention. Other combinations of concentrations, temperature and time are also expected to produce satisfactory floral foams from enzymatic degradation of a cellulose sponge.

TABLE 1

| | Ammonium | | | |
|---|---|---|---|---|
| | phosphate | Cellulase | Reaction | |
| Sample | concentration | concentration | time | |
| name | [Mol/L] | [mg/ml] | (Hrs) | Result |
| Example 1 | 0.05 | 0.2 | 72 | Not degraded enough- |
| | | | | cannot easily be |
| | | | | penetrated by flower |
| | | | | stems |
| Example 2 | 0.05 | 0.2 | 168 | Good |
| Example 3 | 0.10 | 0.2 | 72 | Good |
| Example 4 | 0.10 | 0.2 | 144 | Good |
| Example 5 | 0.10 | 0.1 | 144 | Good |
| Example 6 | 0.10 | 0.1 | 168 | Good |
| Example 7 | 0.10 | 0.2 | 168 | Sponge falls apart-too |
| | | | | much degradation |

### Example 8

A floral foam according to the inventive concept(s) described herein can be prepared from a polylactic acid (PLA) open cell foam according to the following enzymatic degradation procedure. This procedure outlines the use of alcalase enzyme (EC 3.4.21.62) from Bacillus licheniformis. However, other enzymes that degrade PLA could be used with the appropriate reaction conditions (pH, activator, temperature and time). Other examples of suitable enzymes can be found in “Biodegradation of Polylactic Acid (PLA) Fibers Using Different Enzymes”, Lee, et al, Macromolecular Research, Vol. 22, No. 6, pp 657-663 (2014), the teachings of which are incorporated herein in their entirety by reference. Procedure:
Foam sample is submerged in flask containing:
   Tris (hydroxymethyl) amino methane buffer (pH 9.5)
   Alcalase enzyme is added at 50 wt % (based on the weight of the foam)
   3 mM L-cysteine is added to activate the enzyme
   Optionally, Sodium azide (at 0.05 wt %) can be added as an anti-fungal agent
A slight vacuum is pulled on the sample to release air trapped in the foam.
The flask is placed in an oven at 60° C.
The reaction is monitored to identify the desired reaction time, typically 7 to 14 days.
Optionally, the water can be boiled for 5 minutes to deactivate the enzyme. Since the enzyme is not active when the foam is dried, this is not required.
Optionally, a surfactant can be added to increase hydrophilicity of the final foam
The degraded PLA foam is dried

### Examples 9 to 14

A floral foam was made beginning with a cellulose sponge and degrading it with sulfuric acid. A range of conditions were tested, shown in Table 2. Other combinations of time and temperature and the use of other acids are expected to produce a satisfactory floral foam according to the inventive concept(s) described herein.
The following procedure was used:
The cellulose sponge was cut into a cylinder, 2 inches in diameter and 2 inches thick.
Solutions of sulfuric acid in water at the desired molarity were prepared as shown in Table 2.
The sponge was immersed in the sulfuric acid solution.
The beaker was placed in an oven preheated to 50° C. and covered with a piece of glass to minimize evaporation.
Twice per day, the sponge was depressed and released with a spatula to cause the solution in the pores of the sponge to be expelled and refilled.
Sample degradation was checked periodically by poking the sponge with an angled cut plastic pipette tip to mimic a cut flower stem. When the pipette tip could penetrate the wet sponge to the desired degree, the reaction was ended.
To stop the reaction, the beaker was removed from the oven, and the sulfuric acid solution was decanted in a glass vessel.
The sponge was rinsed several times with tap water and then with deionized water, and the pH of the rinse water was monitored. The pH of the soaking solution was about 1.5. After sufficient rinsing the pH changed to a value in the range of 5.5 -5.7.

TABLE 2

| | Sulfuric acid | Oven | Reaction | |
|---|---|---|---|---|
| | concentration | temperature | time | |
| Sample | [Mol/L] | [° C.] | (Hrs) | Result |
| Example 9 | 0.55 | 50 | 20 | Not degraded |
| | | | | enough-cannot |
| | | | | easily be penetrated |
| | | | | by flower stems |
| Example 10 | 1.10 | 50 | 20 | Not degraded |
| | | | | enough-cannot |
| | | | | easily be penetrated |
| | | | | by flower stems |
| Example 11 | 1.65 | 50 | 20 | Good, can easily be |
| | | | | penetrated by flower |
| | | | | stems, |
| Example 12 | 2.00 | 50 | 20 | Good, can easily be |
| | | | | penetrated by flower |
| | | | | stems |
| Example 13 | 3.00 | 50 | 24 | Good, can easily be |
| | | | | penetrated by flower |
| | | | | stems |
| Example 14 | 5.00 | 50 | 20 | Sponge falls apart- |
| | | | | too much degradation |

### Example 15-16

A caramelization reaction is a form of non-enzymatic browning and degradation. It occurs when carbohydrates (often foods) are heated above a certain temperature. The temperature at which caramelization occurs depends on the type of carbohydrate, and the rate depends on the pH (occurring more quickly at neutral pH). Similarly, if a foam is made from a blend of carbohydrates and proteins, heat will cause the Maillard reaction, leading to browning and embrittlement. For example, browning and embrittlement occurs when bread is toasted, but bread is not strong enough to hold flower stems when wet. It was found that cellulose sponge exhibits satisfactory strength/toughness, but can also be made more brittle with heat (allowing insertion of flower stems), yet retain enough mechanical strength when wet to hold flower stems.

Example 15: A 1-inch cube of cellulose sponge was heated in an oven under dry conditions at a temperature of 400° F. (204° C.) for 10 minutes. After cooling and wetting the sponge, it was observed that it had become brittle enough to insert a freshly cut flower stem, yet it retained its absorbent integrity as a sponge.

Example 16: A 1-inch cube of cellulose sponge was heated in an oven under dry conditions at a temperature of 400° F. (204° C.) for 30 minutes. After cooling and wetting the sponge, it was observed that it had become brittle enough to insert a freshly cut flower stem. However, the selected time and temperature was too extreme and not preferred as the color of the sponge had become dark brown. Heating in an oxygen-free environment improves the color.

What is claimed is:

1. An open-cell biodegradable polymeric foam selected from cellulose and polylactic acid having a structure that is capable of supporting stems of cut flowers, said foam being frangible when saturated with water whereby the stems of cut flowers will penetrate the foam without distortion thereof, and said foam having a multiplicity of small bubble-like voids adapted to carry water into the interior thereof.

2. The open-cell polymeric foam of claim 1 which is produced by degrading the polymeric foam material to an extent that it becomes brittle enough to insert and support stems of cut flowers.

3. The open-cell biodegradable polymeric foam of claim 2 which is a cellulose sponge that is degraded by treating it with a cellulase enzyme over a range of pH, enzyme concentrations and temperatures selected to support an enzymatic reaction whereby the cellulose degrades to an extent that it becomes suitable for supporting stems of cut flowers.

4. The open-cell biodegradable polymeric foam of claim 3 wherein the cellulase enzyme is (EC 232-734-4) from Aspergillus Niger.

5. The open-cell biodegradable polymeric foam material of claim 2 which is a polylactic acid sponge that is degraded by exposing it to an alcalase enzyme over a range of pH, enzyme concentration range and temperature range selected to support an enzymatic reaction whereby the polylactic acid sponge degrades to an extent that it becomes suitable for supporting stems of cut flowers.

6. A method for producing a biodegradable polymeric floral foam of the type having a structure that is capable of supporting stems of cut flowers, said foam being frangible when saturated with water whereby the stems of cut flowers will penetrate the foam without distortion thereof, and said foam retaining a multiplicity of small bubble-like voids adapted to carry water into the interior thereof, said method comprising the steps of:
(i) selecting an open-cell polymeric biodegradable foam;
(ii) partially degrading the selected foam whereby the foam structure becomes friable to an extent that cut flower stems can be inserted into and supported by the foam without distortion thereof, said foam retaining a multiplicity of small bubble-like voids adapted to carry water into the interior thereof; and
(iii) terminating the degradation process.

7. The method of claim 6 wherein the open-cell polymeric biodegradable foam is selected from the group consisting of cellulose sponge and polylactic acid sponge.

8. The method of claim 7 wherein the open-cell polymeric biodegradable foam is partially degraded by (i) exposing it to an enzyme over a range of pH, enzyme concentrations and temperatures selected to support an enzymatic reaction whereby the sponge partially degrades to an extent that it becomes suitable for supporting stems of cut flowers while retaining a multiplicity of small bubble-like voids adapted to carry water into the interior thereof; and (ii) terminating the degradation process.

9. The method of claim 8 wherein the open-cell polymeric biodegradable foam is a cellulose sponge and the enzyme is a cellulase enzyme (EC 232-734-4) from Aspergillus Niger.

10. The method of claim 8 wherein the open-cell polymeric biodegradable foam is a polylactic acid sponge and the enzyme is an alcalase enzyme.
